(19) United States
(12) Patent Application Publication
(10) Pub. No.: US 2025/0032960 A1
(43) Pub. Date: Jan. 30, 2025

(54) FILTER PRESS WITH A TWINNED STRUCTURE

(71) Applicant: MATEC INDUSTRIES S.R.L., MILANO (IT)

(72) Inventor: Massimo BERTOLUCCI, MASSA (Ms) (IT)

(21) Appl. No.: 18/713,074

(22) PCT Filed: Nov. 30, 2022
(86) PCT No.: PCT/IT2022/050310

§ 371 Date: May 23, 2024

(30) Foreign Application Priority Data
Dec. 1, 2021 (IT) 102021000030389

(51) Int. Cl. B01D 25/164; B01D 25/19

(52) U.S. Cl. CPC B01D 25/164; B01D 25/19

(57) ABSTRACT

Filter press (100) with a structure comprising: a frame (50); a first fixed shoulder (15) and a first movable shoulder (16), defining a first volume (VI): a second fixed shoulder (17), where said first movable shoulder (16) is arranged between the first and second fixed shoulder (15, 17): first drive means (60) adapted to move the first movable shoulder (16) to vary said first volume (VI), where said filter press (100) further comprises: a second movable shoulder (14), adapted to cooperate with said first fixed shoulder (15) and to define a second volume (V2): a third fixed shoulder (13), where said second movable shoulder (14) is arranged between the first and the third fixed shoulder (15, 13): second drive means (70) adapted to move said second movable shoulder (14) so as to vary said second volume (V2): a manual or automatic control unit (90), adapted to control at least said first drive means (60) and said second drive means (70), and where the first volume (VI) and the second volume (V2) are positioned on opposite sides with respect to said first fixed shoulder (15), which is common to both, along a main longitudinal axis (x) of development of the filter press (100).

### TECHNICAL FIELD

The present invention relates to the field of machines for solid-liquid separation.

In particular, the invention concerns a high productivity filter press with a twinned structure for dewatering sludge.

### BACKGROUND ART

Industrial machines called filter presses, used to dewater sludge by means of a mechanical solid-liquid separation process, are known. In general, a filter press is a machine into which a flow of sludge is pumped, which is treated to obtain filtered liquid, typically water, and solid blocks. From a construction viewpoint, a filter press is generally composed of filter plates arranged in series and supported by a frame. A filter press according to the prior art is operated by means of one or more pneumatic cylinders that move the filter plates between a “closed” configuration, where the filter plates are pressed, and an “open” configuration, where the filter plates are released. When the plates are in closed configuration, the sludge inside the plates is dewatered to form solid blocks while the filtered liquid is discharged and if possible reused.

The filter presses described above have some limits and drawbacks.

According to a first aspect, the operating process of filter presses is restricted to the times dictated by the cycle between the open configuration and the closed configuration. In other words, the amount of sludge to be treated and the duration of the process for obtaining correct dewatering are restricted, thus limiting the productivity of the movement imparted to the plate of the machine.

### Presentation of the Invention

The object of the invention is to provide a filter press that, given the same overall dimensions, is more productive with respect to the current state of the art in terms of operating times and amount of sludge to be treated.

Another object of the invention is to provide a filter press that is optimized from the viewpoint of surface occupied, reducing the overall dimensions of the machine.

Yet another object of the invention is to provide a filter press that is optimized from a financial viewpoint, reducing the cost of the structures and of the engineering works required for operation.

The object of the invention is achieved with a filter press with a twinned structure according to the principal independent claim 1.

Further features of this filter press are described in the dependent claims.

A filter press according to the present invention produces the following important advantages:
the twinned structure with mirror symmetry presses, given by a double movable shoulder and by a fixed shoulder in common, allows an increase in the productivity of the machine and at the same time balancing of the forces acting on the common fixed shoulder during normal operation of the machine;
the two movable shoulders can be moved independently from one another, as each has its own autonomous movement system, hence making it possible to stop only a portion of the machine, in particular to carry out maintenance (for example to change the filter plates), while the opposite portion is free to operate normally.

### BRIEF DESCRIPTION OF THE DRAWINGS

These and other advantages of the invention will be more apparent below, where preferred embodiments are described purely by way of non-limiting example and with the aid of the figures, wherein:

FIGS. 1 and 2 illustrate, respectively in a front and top plan view, a filter press according to a preferred variant of embodiment;

FIG. 3 illustrates in a side plan view the filter press of FIG. 1;

FIGS. 4A and 4B illustrate, respectively in a front and top plan view, a first portion of the filter press of FIG. 1;

FIGS. 5A and 5B illustrate, respectively in a front and top plan view, a second portion of the filter press of FIG. 1.

### DETAILED DESCRIPTION OF A PREFERRED EMBODIMENT OF THE INVENTION

The new filter press forming the subject matter of the following description is susceptible to modifications and/or variants, all falling within the present invention; moreover, all details can be replaced by technically equivalent elements. Finally it should be noted that, for clarity of illustration, some numerical references may not have been repeated in all the figures.

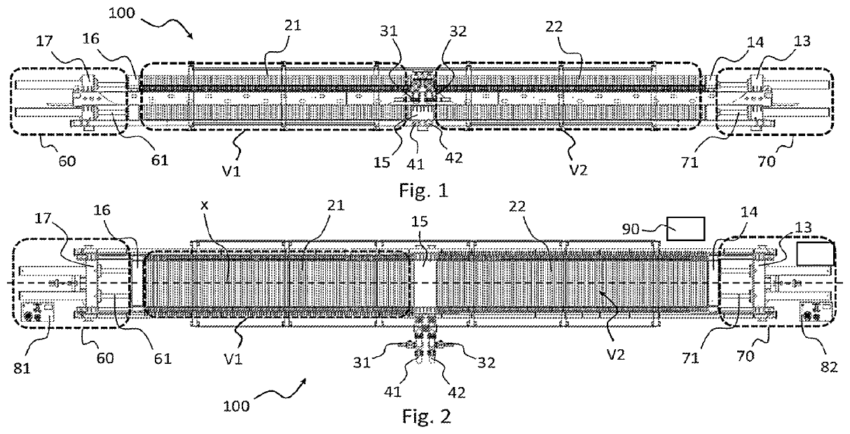

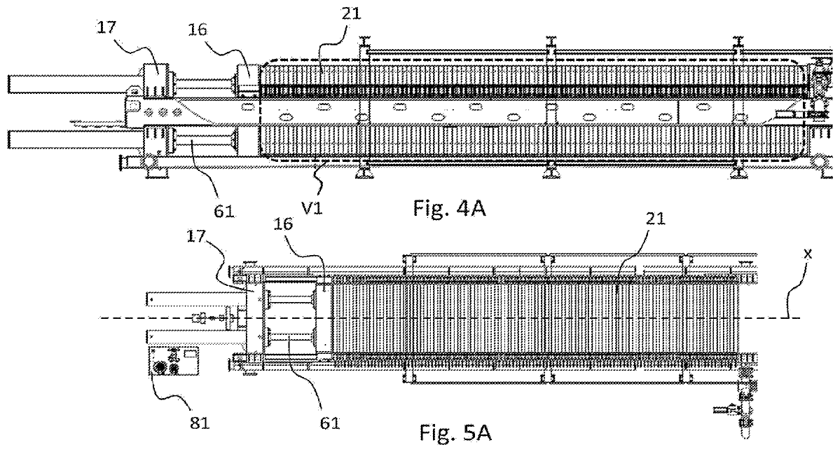

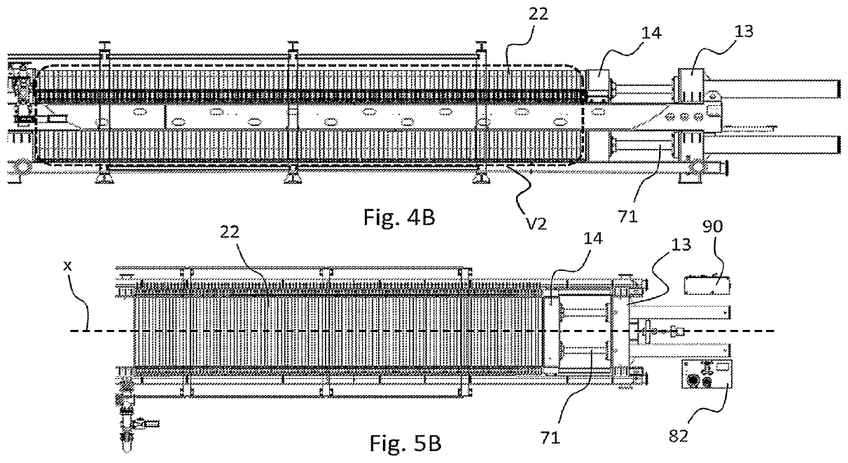

With reference to FIGS. 1-5, the invention concerns a filter press 100 with a twinned structure for dewatering sludge substantially comprising:
a frame 50;
a first fixed shoulder 15 and a first movable shoulder 16, adapted to cooperate with one another and to define a first volume V1 that can vary between a maximum value and a minimum value;
a first plurality of filter plates 21 arranged between said first fixed shoulder 15 and said first movable shoulder 16;
a second fixed shoulder 17, where said first movable shoulder 16 is arranged between said first fixed shoulder 15 and said second fixed shoulder 17;
first drive means 60 adapted to move said first movable shoulder 16 so as to vary said first volume V1.

In particular, said filter press further comprises:
a second movable shoulder 14, adapted to cooperate with said first fixed shoulder 15 and to define a second volume V2 that can vary between a maximum value and a minimum value;
a second plurality of filter plates 22 arranged between said first fixed shoulder 15 and said second movable shoulder 14;
a third fixed shoulder 13, where said second movable shoulder 14 is arranged between said first fixed shoulder 15 and said third fixed shoulder 13;
second drive means 70 adapted to move said second movable shoulder 14 so as to vary said second volume V2;
a manual or automatic control unit 90, adapted to control at least said first drive means 60 and said second drive means 70,
   where the first volume V1 and the second volume V2 are positioned on the opposite sides with respect to said first fixed shoulder 15, which is common to both, along a main longitudinal axis “x” of development of the filter press 100.

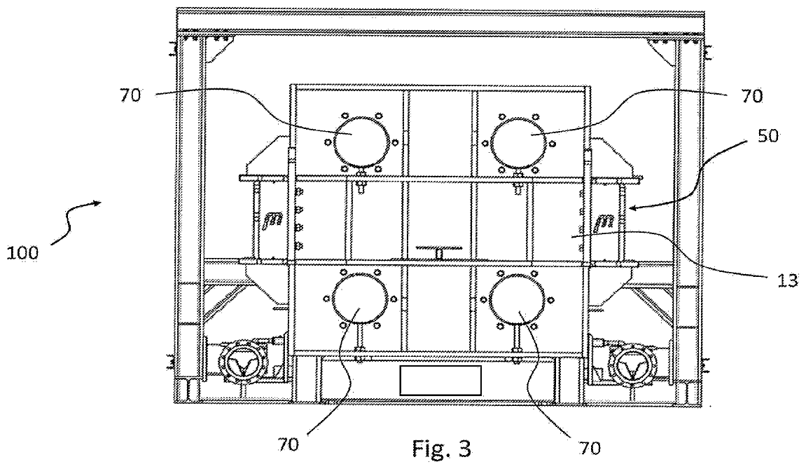

In the filter press described, the frame 50 (for example, partially visible in FIG. 3) is typically coupled to a foundation in the ground and is adapted to act as supporting structure of the elements forming the filter press 100.

With reference in particular to FIG. 2, said filter press 100 develops along the main longitudinal axis “x”. Advantageously, the second fixed shoulder 17 is positioned at a first end zone of the filter press 100 and the third fixed shoulder 13 is positioned at a second end zone of the filter press 100. Preferably, the first fixed shoulder 15 is arranged between said second fixed shoulder 17 and said third fixed shoulder 13, in particular in a central zone arranged symmetrically between said second fixed shoulder 17 and said third fixed shoulder 13.

In the filter press as described:
said first movable shoulder 16 and said second movable shoulder 14 are adapted to cooperate with said first fixed shoulder 15; in other words, said first fixed shoulder 15 acts as fixed end both of said first volume V1, and of said second volume V2;
said first volume V1 can vary between a maximum value where said first movable shoulder 16 is far from said first fixed shoulder 15 and a minimum value where said first movable shoulder 16 is near said first fixed shoulder 15;
said second volume V2 can vary between a maximum value where said second movable shoulder 14 is far from said first fixed shoulder 15 and a minimum value where said second movable shoulder 14 is near said first fixed shoulder 15;
said first plurality of filter plates 21 is adapted to occupy at least partially said first volume V1;
said second plurality of filter plates 22 is adapted to occupy at least partially said second volume V2.

As better explained below, said first drive means 60 and said second drive means 70 are adapted to move said first movable shoulder 16 and said second movable shoulder 14. In particular, said first drive means 60 are adapted to move:
said first movable shoulder 16 between said maximum value, where the filter plates of said first plurality of filter plates 21 are spaced from one another, and said minimum value, where the filter plates of said first plurality of filter plates 21 are compact with one another;
said second movable shoulder 14 between said maximum value, where the filter plates of said second plurality of filter plates 22 are spaced from one another, and said minimum value, where the filter plates of said second plurality of filter plates 22 are compact with one another;

Advantageously, during normal operation of the filter press 100, said first movable shoulder 16 and said second movable shoulder 14 are moved at the same time. In particular, when said first movable shoulder 16 and said second movable shoulder 14 are moved at the same time, said movable shoulders 16,14 occupy at all times a position with mirror symmetry with respect to said first fixed shoulder 15.

Advantageously, during extraordinary operation of the filter press 100, for example for maintenance, said first movable shoulder 16 and said second movable shoulder 14 are moved independently from one another. In particular, when said first movable shoulder 16 and said second movable shoulder 14 are moved independently, said movable shoulders 16,14 occupy any position with respect to said first fixed shoulder 15.

It should be noted that said first movable shoulder 16 and/or said second movable shoulder 14 can also be kept stopped, in any position that defines said maximum value and said minimum value of said volume V1 and/or said volume V2.

In particular, said first drive means 60 and said second drive means 70 are adapted to move said first movable shoulder 16 and said second movable shoulder 14 along said main longitudinal axis “x”.

In particular, in the filter press 100 said first drive means 60 and said second drive means 70 are adapted to move said first movable shoulder 16 and said second movable shoulder 14 along the main longitudinal axis “x” in both the directions defined thereby.

Advantageously, during normal operation of the filter press 100, said first drive means 60 and said second drive means 70 are adapted to move said first movable shoulder 16 and said second movable shoulder 14 at the same time.

Even more advantageously, during normal operation of the filter press 100, said first drive means 60 and said second drive means 70 are adapted to move said first movable shoulder 16 and said second movable shoulder 14 in opposite directions.

It should be noted that, during extraordinary operation of the filter press 100, said first drive means 60 and said second drive means 70 can move said first movable shoulder 16 and said second movable shoulder 14 along the main longitudinal axis “x” with different methods from those described for normal operation of the filter press 100.

For example, during extraordinary operation of the filter press 100, said first movable shoulder 16 is kept stopped in a position far from said first fixed shoulder 15 (i.e., at the maximum value of said first volume V1), while said second movable shoulder 14 is moved so as to move from the position farthest from said first fixed shoulder 15 (i.e., at the maximum value of said second volume V2) to the position nearest to said first fixed shoulder 15 (i.e., at the minimum value of said second volume V2) and vice versa.

Said first drive means 60 comprise:
first hydraulic pistons 61 operationally connected between said first movable shoulder 16 and said second fixed shoulder 17;
a first pressurization circuit containing a first hydraulic fluid;
a first valve system adapted to control the working pressure of said first hydraulic fluid.

Advantageously, said first hydraulic pistons 61 are fluidically connected to said first pressurization circuit.

In particular, said first valve system is regulate by a hydraulic control unit 81 so as to vary the working pressure of said first hydraulic fluid fed to said first hydraulic pistons 61; advantageously said hydraulic control unit 81 is controlled by said control unit 90.

Said second drive means 70 comprise:
second hydraulic pistons 1 operationally connected between said second movable shoulder 14 and said third fixed shoulder 13;
a second pressurization circuit containing a second hydraulic fluid;
a second valve system adapted to control the working pressure of said second hydraulic fluid.

Advantageously, said second hydraulic pistons 71 are fluidically connected to said second pressurization circuit.

In particular, said second valve system is regulated by a hydraulic control unit 82 so as to vary the working pressure of said second hydraulic fluid fed to said second hydraulic pistons 71; advantageously said hydraulic control unit 82 is controlled by said control unit 90.

It should be noted that said first hydraulic fluid and said second hydraulic fluid can be the same or different.

It should also be noted that said control unit 90 is a central control unit, capable of controlling said first and said second valve system independently.

The filter press 100, in the variant illustrated in FIGS. 1 and 2, further comprises:
a first hydraulic circuit adapted to feed to a first inlet 31 a fluid to be treated in said first volume V1;
a second hydraulic circuit adapted to feed to a first inlet 32 a fluid to be treated in said second volume V2.

According to a possible example of embodiment, said first hydraulic circuit and said second hydraulic circuit are at least partially connected.

Advantageously, said first hydraulic circuit and/or said second hydraulic circuit are adapted to feed said fluid to be treated when said first volume V1 and/or said second volume V2 have a minimum value, i.e., when each pack of plates is closed and pressurized; in other words, said fluid to be treated is fed to said first inlet 31 and/or said second inlet 32 when said first movable shoulder 16 is near said first fixed shoulder 15 and/or when said second movable shoulder 14 is near said first fixed shoulder 15.

The filter press 100, in the variant illustrated in FIGS. 1 and 2, further comprises:
a third hydraulic circuit adapted to drain from a first outlet 41 a fluid treated in said first volume V1;
a fourth hydraulic circuit adapted to drain from a second outlet 42 a fluid treated in said second volume V2.

According to a possible example of embodiment, said third hydraulic circuit and said fourth hydraulic circuit are at least partially connected.

Advantageously, said third hydraulic circuit and/or said fourth hydraulic circuit are in turn adapted to drain from the outlet said treated fluid when said first volume V1 and/or said second volume V2 have a minimum value; in other words, said treated fluid is drained from said first outlet 41 and/or said second outlet 42 when said first movable shoulder 16 is near said first fixed shoulder 15 and/or when said second movable shoulder 14 is near said first fixed shoulder 15.

Advantageously, the filter press 100 further comprises:
a first kinematic system of known type adapted to remove a plurality of blocks of solid material separated from said fluid treated in said first volume V1;
a second kinematic system of known type adapted to remove a plurality of blocks of solid material separated from said fluid treated in said second volume V2.

In other words, said first kinematic system and said second kinematic system are adapted to remove the solid material, typically in the form of blocks, which stops between two consecutive filter plates of said first plurality of filter plates 21 and/or said second plurality of filter plates 22.

1. Filter press (100) with a twinned structure comprising:
a frame (50);
a first fixed shoulder (15) and a first movable shoulder (16), said first fixed shoulder (15) and said first movable shoulder (16) being adapted to cooperate with one another and to define a first volume (V1) that can vary between a maximum value where said first movable shoulder (16) is far from said first fixed shoulder (15) and a minimum value where said first movable shoulder (16) is near said first fixed shoulder (15);
a first plurality of filter plates (21) arranged between said first fixed shoulder (15) and said first movable shoulder (16) and adapted to occupy at least partially said first volume (V1);
a second fixed shoulder (17), where said first movable shoulder (16) is arranged between said first fixed shoulder (15) and said second fixed shoulder (17);
first drive means (60) adapted to move said first movable shoulder (16) so as to vary said first volume (V1),
characterised in that it further comprises:
a second movable shoulder (14), said second movable shoulder (14) being adapted to cooperate with said first fixed shoulder (15) and to define a second volume (V2) that can vary between a maximum value where said second movable shoulder (14) is far from said first fixed shoulder (15) and a minimum value where said second movable shoulder (14) is near said first fixed shoulder (15);
a second plurality of filter plates (22) arranged between said first fixed shoulder (15) and said second movable shoulder (14) and adapted to occupy at least partially said second volume (V2);
a third fixed shoulder (13), where said second movable shoulder (14) is arranged between said first fixed shoulder (15) and said third fixed shoulder (13);
second drive means (70) adapted to move said second movable shoulder (14) so as to vary said second volume (V2);
a manual or automatic control unit (90), adapted to control at least said first drive means (60) and said second drive means (70),
where the first volume (V1) and the second volume (V2) are positioned on opposite sides with respect to said first fixed shoulder (15), which is common to both, along a main longitudinal axis (x) of development of the filter press (100).

2. Filter press (100) according to claim 1, characterised in that said first drive means (60) and said second drive means (70) are adapted to move said first movable shoulder (16) and said second movable shoulder (14) respectively along said main longitudinal axis (x).

3. Filter press (100) according to claim 2, characterised in that said first drive means (60) and said second drive means (70) are adapted to move said first movable shoulder (16) and said second movable shoulder (14) respectively along said main longitudinal axis (x) in both directions.

4. Filter press (100) according to claim 1, characterised in that said first drive means (60) e said second drive means (70) are adapted to move said first movable shoulder (16) and said second movable shoulder (14) respectively at the same time.

5. Filter press (100) according to claim 4, characterised in that said first drive means (60) and said second drive means (70) are adapted to move said first movable shoulder (16) and said second movable shoulder (14) respectively in opposite directions.

6. Filter press (100) according to claim 1, characterised in that said first drive means (60) comprise first hydraulic pistons (61) operationally connected between said first movable shoulder (16) and said second fixed shoulder (17).

7. Filter press (100) according to claim 1, characterised in that said second drive means (70) comprise second hydraulic pistons (71) operationally connected between said second movable shoulder (14) and said third fixed shoulder (13).

8. Filter press (100) according to claim 6, characterised in that said first drive means (60) further comprise a first pressurization circuit containing a first hydraulic fluid, and in that said first hydraulic pistons (61) are fluidically connected to said first pressurization circuit.

9. Filter press (100) according to claim 7, characterised in that said second drive means (70) further comprise a second pressurization circuit containing a second hydraulic fluid, and in that said second hydraulic pistons (71) are fluidically connected to said second pressurization circuit.

10. Filter press (100) according to claim 8, characterised in that it further comprises a first valve system and/or a second valve system, said first valve system being adapted to control the working pressure of said first hydraulic fluid and said second valve system being adapted to control the working pressure of said second hydraulic fluid.

11. Filter press (100) according to claim 1, characterised in that it further comprises a first hydraulic circuit and/or a second hydraulic circuit, said first hydraulic circuit being adapted to feed to a first inlet (31) a fluid to be treated in said first volume (V1) and said second hydraulic circuit being adapted to feed to a second inlet (32) a fluid to be treated in said second volume (V2).

12. Filter press (100) according to claim 1, characterised in that said first hydraulic circuit and/or said second hydraulic are adapted to feed said fluid to be treated when said first volume (V1) and/or said second volume (V2) have a minimum value.

13. Filter press (100) according to claim 1, characterised in that it further comprises a third hydraulic circuit and/or a fourth hydraulic circuit, said third hydraulic circuit being adapted to drain from a first outlet (41) a fluid treated in said first volume (V1) and said fourth hydraulic circuit being adapted to drain from a second outlet (42) a fluid treated in said second volume (V2).

14. Filter press (100) according to claim 13, characterised in that said third hydraulic circuit and/or said fourth hydraulic circuit are adapted to drain said treated fluid when said first volume (V1) and/or said second volume (V2) have a minimum value.

15. Filter press (100) according to claim 13, characterised in that it further comprises a first kinematic system and/or a second kinematic system, said first kinematic system being adapted to remove a plurality of blocks of solid material separated from said fluid treated in said first volume (V1) and said second kinematic system being adapted to remove a plurality of blocks of solid material separated from said fluid treated in said second volume (V2).
